(19) United States
(12) Patent Application Publication
(10) Pub. No.: US 2026/0192602 A1
(43) Pub. Date: Jul. 9, 2026

(54) TIRE

(71) Applicant: The Yokohama Rubber Co., LTD., Kanagawa (JP)

(72) Inventor: Shunya HIDANO, Kanagawa (JP)

(21) Appl. No.: 19/440,045

(22) Filed: Jan. 5, 2026

(30) Foreign Application Priority Data
Jan. 8, 2025 (JP) 2025-003116

(51) Int. Cl. B60C 11/03; B60C 9/20

(52) U.S. Cl. CPC B60C 11/0306; B60C 9/20; B60C 11/0304; B60C 2009/2012; B60C 2011/0348

(57) ABSTRACT

Tread portion of a tire includes center land portion defined by outermost circumferential main grooves and shoulder land portions on outer sides of the outermost circumferential main grooves in the width direction. Circumferential belt layer includes belt cords having an inclination angle relative to the circumferential direction of 5 degrees or smaller. Ratio of a center land portion width CW to a tread development width TW is within a range of 0.40-0.65. Ratio of a shoulder land portion width SW to a value obtained by subtracting the center land portion width CW from the tread development width TW and dividing a subtracted value by two is within a range of 0.50-0.90. Circumferential belt layer has end portions in the width direction located on outer sides of the outermost circumferential main grooves in the width direction and within a range of 0.90 or less of the tread development width TW.

### CROSS-REFERENCE TO RELATED APPLICATION

This application claims priority pursuant to 35 U.S.C. 119(a) to Japanese Patent Application No. 2025-003116, filed Jan. 8, 2025, which application is incorporated herein by reference in its entirety.

### FIELD OF THE INVENTION

The present technology relates to a tire.

### BACKGROUND

In a tire mounted on a vehicle, grooves are formed in a tread portion for the purpose of ensuring various performances in accordance with a use mode of the tire, and in the tread portion, a belt layer as a reinforcement layer is disposed. For known tires, their performance is improved by devising the shape of the grooves or devising the belt layer.

For example, a heavy duty tire described in Japan Unexamined Patent Publication No. 2017-007424 includes a circumferential belt layer, a pair of circumferential main grooves extending in the tire circumferential direction with a tire equatorial plane interposed therebetween, and a plurality of circumferential narrow grooves extending in the tire circumferential direction in a central region between the pair of circumferential main grooves. A distance in the tire width direction of the circumferential belt layer is larger than a distance in the tire width direction between both narrow grooves including groove widths of two circumferential narrow grooves located outermost in the tire width direction with the tire equator interposed therebetween. The tire described in Japan Unexamined Patent Publication No. 2023-522875 includes at least one high elongation belt applied as a single cord strip on the outer side in a radial direction of the carcass and having a belt cord angle equal to 0 degrees and an outer tread portion provided with two or more grooves extending along a circumferential direction. The axial width of both grooves measured along an axial direction parallel to the axis of rotation of the tire and perpendicular to the circumferential direction is less than 2 mm or at least equal to 2 mm.

A tread pattern in which the land portion of the tread portion is defined by circumferential narrow grooves and the land portion is brought closer to the central region in the tire width direction can improve rigidity of the land portion located in the central region in the tire width direction and is effective in reducing rolling resistance but relatively decreases rigidity of the land portion located at or near the shoulder portions of the tread portion. In this case, uneven wear known as shoulder wear tends to occur, causing an excessive wear on the land portion at or near the shoulder portion due to a difference in rigidity between the land portion and the shoulder portion.

In recent years, even tires with a rib pattern sometimes need to perform well on snow, and the circumferential narrow grooves can ensure the rigidity of the land portion by closing the grooves when the land portion is brought into contact with the ground. In this way, the circumferential narrow grooves close when the tire contacts the ground to ensure the rigidity of the land portion. However, when the circumferential narrow grooves close when contacting the ground, it may be difficult to have sufficient groove volume and the traction performance on snow. For this reason, it has been very difficult to reduce rolling resistance while suppressing shoulder wear and further ensure traction performance on snow.

### SUMMARY

The present technology provides a tire that can reduce the rolling resistance while suppressing the shoulder wear and ensure the traction performance on snow.

A tread portion of a tire includes a center land portion defined by outermost circumferential main grooves and shoulder land portions on outer sides of the outermost circumferential main grooves in the width direction. A circumferential belt layer includes belt cords having an inclination angle relative to the circumferential direction of 5 degrees or smaller. A ratio of a center land portion width CW to a tread development width TW is within a range of 0.40-0.65. A ratio of a shoulder land portion width SW to a value obtained by subtracting the center land portion width CW from the tread development width TW and dividing a subtracted value by two is within a range of 0.50-0.90. The circumferential belt layer has end portions in the width direction located on outer sides of the outermost circumferential main grooves in the width direction and within a range of 0.90 or less of the tread development width TW.

A tire according to an embodiment of the present technology includes a tread portion having a plurality of circumferential main grooves extending in a tire circumferential direction and a plurality of land portions defined by the circumferential main grooves; and a belt layer disposed in the tread portion including a plurality of belt plies. The tread portion includes a center land portion that is a land portion of the land portion defined by a pair of outermost circumferential main grooves each disposed at an outermost side in the tire width direction among the plurality of circumferential main grooves and shoulder land portions that are land portions of the land portions located on outer sides of the outermost circumferential main grooves in the tire width direction. In the center land portion, a plurality of circumferential narrow grooves extending in the tire circumferential direction and a plurality of width direction narrow grooves extending in the tire width direction being disposed. The belt layer includes a pair of cross belts including belt cords having inclination directions in the tire width direction with respect to the tire circumferential direction opposite to each other and a circumferential belt layer disposed between the pair of cross belts and including the belt cords each having an inclination angle in the tire width direction with respect to the tire circumferential direction of 5 degrees or smaller. The center land portion has a ratio of a width of the center land portion in the tire width direction to a tread development width within a range of 0.40 or more and 0.65 or less. The shoulder land portions each have a ratio of a width of the shoulder land portions in the tire width direction to a value obtained by subtracting the width of the center land portion in the tire width direction from the tread development width and dividing a subtracted value by two within a range of 0.50 or more and 0.90 or less. The circumferential belt layer has end portions in the tire width direction located on outer sides of the outermost circumferential main grooves in the tire width direction and within a range of 0.90 or less of the tread development width.

The tire according to an embodiment of the present technology has the effect of reducing the rolling resistance while suppressing the shoulder wear and ensure the traction performance on snow.

### BRIEF DESCRIPTION OF THE DRAWINGS

FIG. 1 is a tire meridian cross-sectional view illustrating a main portion of a pneumatic tire according to an embodiment.

FIG. 2 is a schematic diagram of a belt layer illustrated in FIG. 1;

FIG. 3 is a detailed view at or near the end portion of the belt layer illustrated in FIG. 1;

FIG. 4 is a plan view of a tread portion illustrated in FIG. 1;

FIG. 5 is a cross-sectional view taken along line A-A of FIG. 4;

FIG. 6 is a cross-sectional view taken along line B-B of FIG. 4;

FIG. 7 is a detailed view of blocks provided in a center land portion illustrated in FIG. 4;

FIG. 8A is a table showing results of performance evaluation tests of pneumatic tires; and,

FIG. 8B is a table showing results of performance evaluation tests of pneumatic tires.

### DETAILED DESCRIPTION OF THE INVENTION

An embodiment according to the present technology will be described in detail below with reference to the drawings. However, the technology is not limited to the embodiments. Constituents of the embodiment include elements that are substitutable while maintaining consistency with the technology and elements that are obviously substitutable. A plurality of modified examples described in the embodiments can be combined as desired within the scope apparent to those who are skilled in the art.

### Embodiments

In the following description, the term “tire radial direction” refers to a direction orthogonal to the tire rotation axis (not illustrated), which is a rotation axis of a pneumatic tire 1, the term “inner side in the tire radial direction” refers to a side toward the tire rotation axis in the tire radial direction, and the term “outer side in the tire radial direction” refers to a side away from the tire rotation axis in the tire radial direction of the embodiment. The term “tire circumferential direction” refers to a circumferential direction with the tire rotation axis as a center axis. The term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The term “tire equator line” refers to a line in the tire circumferential direction of the pneumatic tire 1 that lies on the tire equatorial plane CL. The term “cross-section in the tire meridian direction (meridian cross-sectional view)” refers to a cross section of the tire taken along a plane that includes the tire rotation axis.

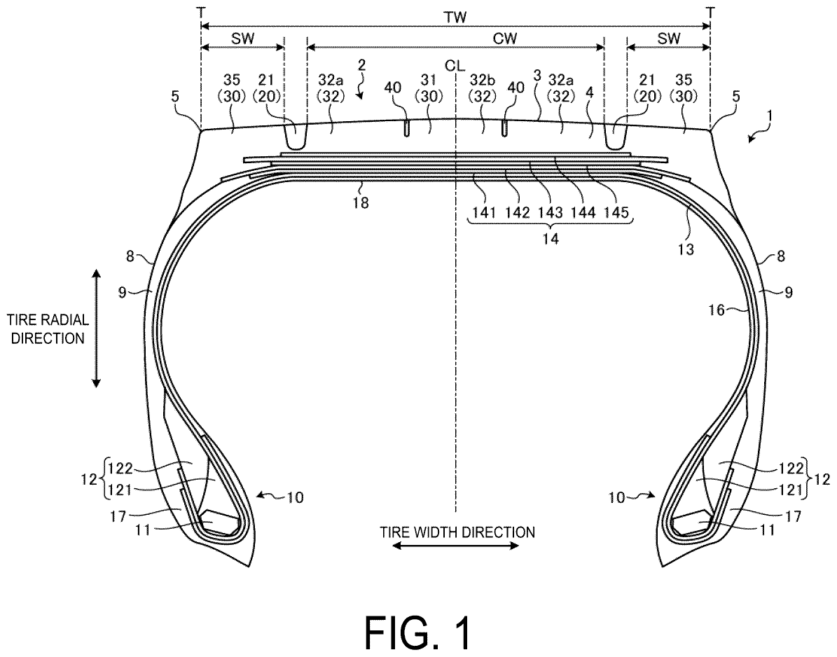

FIG. 1 is a tire meridian cross-sectional view illustrating a main portion of the pneumatic tire 1 according to an embodiment. FIG. 1 illustrates a meridional cross section of the pneumatic tire 1 according to an embodiment, the cross section of one side region of a tire rotation axis in a tire radial direction. In the present embodiment, a heavy duty pneumatic radial tire mounted on a heavy duty vehicle, such as a truck or bus, will be described as an example.

In the pneumatic tire 1 according to the present embodiment, a tread portion 2 is disposed on a portion on the outermost side in the tire radial direction when viewed in a tire meridian cross section, and the tread portion 2 includes a tread rubber 4 made of a rubber composition. Additionally, a surface of the tread portion 2, that is, a portion that comes into contact with road surfaces when driving a vehicle (not illustrated) on which the pneumatic tires 1 are mounted is formed as a tread ground contact surface 3, and the tread ground contact surface 3 forms a portion of a contour of the pneumatic tire 1.

A shoulder portion 5 is located at both ends on the outer side of the tread portion 2 in the tire width direction, and a sidewall portion 8 is disposed on the inner side of the shoulder portion 5 in the tire radial direction. In other words, the sidewall portions 8 are disposed on both sides of the tread portion 2 in the tire width direction. In other words, the sidewall portions 8 are disposed at two locations on both sides of the pneumatic tire 1 in the tire width direction, and form portions exposed to the outermost side of the pneumatic tire 1 in the tire width direction. The sidewall portions 8 each include a sidewall rubber 9 made of a rubber composition.

A bead portion 10 is provided on the inner side of each of the side wall portions 8 in the tire radial direction located on both sides in the tire width direction. Like the sidewall portions 8, the bead portion 10 is disposed at two locations on both sides of the tire equatorial plane CL. In other words, a pair of bead portions 10 is disposed on both sides of the tire equatorial plane CL in the tire width direction. The bead portions 10 each include a bead core 11, and a bead filler 12 is provided on the outer side of the bead core 11 in the tire radial direction.

The bead core 11 is an annular member formed in an annular shape by bundling bead wires made of steel wires and winding those multiple times annularly. The bead filler 12 includes a lower filler 121 and an upper filler 122 which are rubber members and is disposed on the outer side of each bead core 11 in the tire radial direction to reinforce the bead portions 10.

A carcass layer 13 containing cords of radial plies is continuously provided on the inner side of the tread portion 2 in the tire radial direction and on the tire equatorial plane CL side of the sidewall portions 8. Accordingly, the pneumatic tire 1 according to the present embodiment is configured as a so-called radial tire. The carcass layer 13 has a single layer structure made of one carcass ply or a multilayer structure made of a plurality of carcass plies, and spans between the pair of bead portions 10 disposed on both sides in the tire width direction in a toroidal shape to form a framework of the tire.

Specifically, the carcass layer 13 is disposed to span from one bead portion 10 to the other bead portion 10 among the bead portions 10 located on both sides in the tire width direction and is turned up toward the outer side in the tire width direction along the bead cores 11 at the bead portions 10 so as to wrap around the bead cores 11 and the bead fillers 12. The bead fillers 12 are rubber members each disposed in a space on the outer side of the bead core 11 in the tire radial direction, the space being formed by folding the carcass layer 13 back at the bead portion 10. Additionally, the carcass ply of the carcass layer 13 is formed by covering a plurality of carcass cords made of steel with coating rubber and conducting a rolling process thereon. The plurality of carcass cords forming the carcass ply is disposed in parallel at an angle in the tire circumferential direction, the angle with respect to the tire circumferential direction being along a tire meridian direction. Specifically, the angle of the carcass cords relative to the tire circumferential direction is within a range of 80 degrees or larger and 90 degrees or smaller in absolute value.

At the bead portion 10, a rim cushion rubber 17, which constitutes a contact surface of the bead portion 10 with respect to a rim flange, is disposed on the inner side in the tire radial direction and the outer side in the tire width direction of the winding portion of the bead core 11 and the carcass layer 13. Additionally, an innerliner 16 is formed along the carcass layer 13 on the inner side of the carcass layer 13 or on the inner portion side of the carcass layer 13 in the pneumatic tire 1. The innerliner 16 forms a tire inner surface 18 that is a surface on the inner side of the pneumatic tire 1.

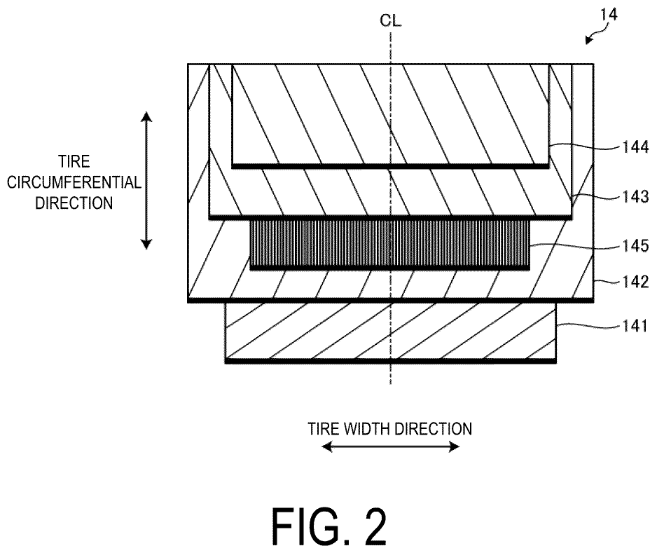

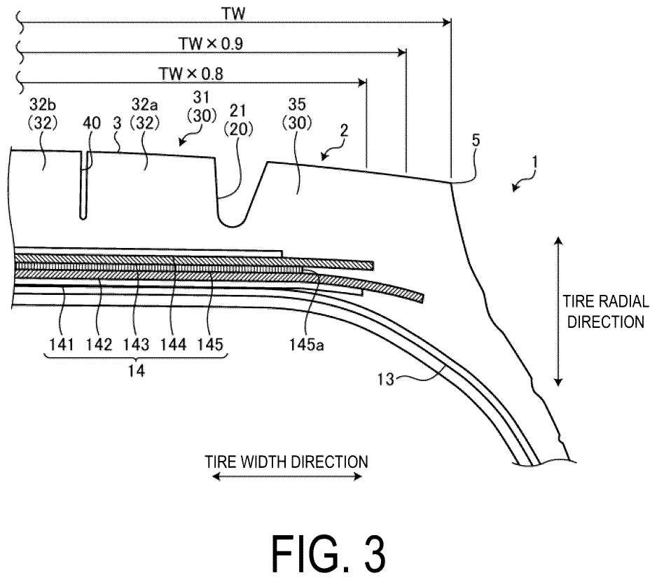

A belt layer 14 is disposed in the tread portion 2. FIG. 2 is a schematic diagram of the belt layer 14 illustrated in FIG. 1. FIG. 3 is a detailed view at or near the end portion of the belt layer 14 illustrated in FIG. 1. The belt layer 14 is disposed on the outer side of a portion located on the tread portion 2 in the tire radial direction in the carcass layer 13 spanning between the pair of bead portions 10. The belt layer 14 has a multilayer structure including a plurality of belt plies 141 to 145 and is disposed around the outer circumference of the carcass layer 13. The belt plies 141 to 145 includes a large-angle belt 141, a pair of cross belts 142 and 143, a belt cover 144, and a circumferential belt layer 145.

The large-angle belt 141 is formed by covering a plurality of belt cords made of steel wires with coating rubber and conducting a rolling process thereon, and has a cord angle (defined as an inclination angle of the belt cord in a longitudinal direction thereof with respect to the tire circumferential direction) of 45 degrees or greater and 70 degrees or smaller, and preferably 54 degrees or greater and 68 degrees or smaller in absolute value. Additionally, the large-angle belt 141 is disposed in a layered manner on the outer side of the carcass layer 13 in the tire radial direction.

The pair of cross belts 142 and 143 is formed by covering a plurality of belt cords made of steel wires with coating rubber and conducting a rolling process thereon and has a cord angle of 10 degrees or greater and 45 degrees or smaller, preferably 14 degrees or greater and 28 degrees or smaller in absolute value. The pair of cross belts 142 and 143 have cord angles having mutually opposite signs and is layered by making the belt cords mutually intersect in the longitudinal direction of the belt cords (a so-called crossply structure is formed). In other words, the inclination directions of the belt cords of the pair of cross belts 142 and 143 in the tire width direction with respect to the tire circumferential direction are opposite to each other. Also, the pair of cross belts 142 and 143 are disposed in a layered manner on the outer side of the large-angle belt 141 in the tire radial direction. Here, the cross belt 142 located on the inner side in the tire radial direction is defined as an inner cross belt, and the cross belt 143 located on the outer side in the tire radial direction is defined as an outer cross belt.

The belt cover 144 is formed by covering a plurality of belt cover cords made of steel wires or an organic fiber material with coating rubber and conducting a rolling process thereon and has a cord angle of 10 degrees or greater and 45 degrees or smaller, preferably 14 degrees or greater and 28 degrees or smaller in absolute value. Also, the belt cover 144 is disposed in a layered manner on the outer side of the cross belts 142 and 143 in the tire radial direction. In the present embodiment, the belt cover 144 has the same cord angle as the outer cross belt 143 and is disposed in the outermost layer of the belt layer 14.

The circumferential belt layer 145 is formed by spirally winding a belt cord made of steel wires covered with coating rubber in the tire circumferential direction and has a cord angle of 5 degrees or smaller in absolute value. In other words, the circumferential belt layer 145 includes belt cords each having an inclination angle in the tire width direction with respect to the tire circumferential direction of 5 degrees or smaller. The circumferential belt layer 145 is disposed between the pair of cross belts 142 and 143. The circumferential belt layer 145 is made to have a width in the tire width direction narrower than the width of the cross belts 142 and 143 in the tire width direction. Thus, the circumferential belt layer 145 is disposed on the inner side in the tire width direction of both end portions of the pair of cross belts 142 and 143 in the tire width direction. Specifically, the circumferential belt layer 145 is formed by winding one or a plurality of wires spirally around the outer circumference of the inner cross belt 142. The circumferential belt layer 145 is disposed continuously in the tire width direction to extend across the tire equatorial plane CL in the tire width direction.

In the present embodiment, the circumferential belt layer 145 has several ends of the belt cords, i.e., several embedded belt cords per unit width, within a range of 15 cords/50 mm or more and 30 cords/50 mm or less. An outer diameter of belt cords is within a range of 1.2 mm or more and 2.2 mm or less. In a configuration in which the belt cords are made of the plurality of cords twisted together, the diameter of a circle that circumscribes the belt cords is measured as a belt cord diameter.

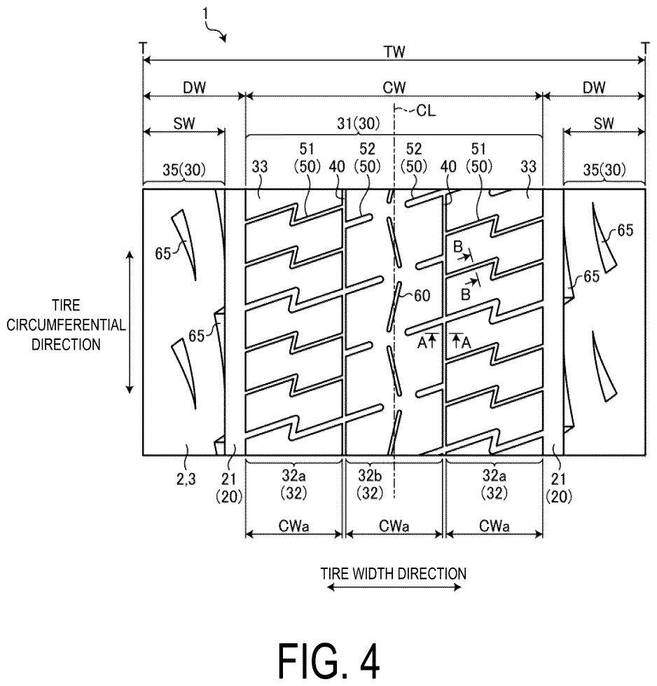

FIG. 4 is a plan view of the tread portion 2 illustrated in FIG. 1. A plurality of circumferential main grooves 20 extending in the tire circumferential direction are disposed in a tread ground contact surface 3 of the tread portion 2, and a plurality of land portions 30 are defined by the plurality of circumferential main grooves 20 on the surface of the tread portion 2. In the present embodiment, only two circumferential main grooves 20 are disposed. The two circumferential main grooves 20 are disposed one on each side of the tire equatorial plane CL in the tire width direction.

Here, the circumferential main grooves 20 are longitudinal grooves each extending in the tire circumferential direction and internally having a wear indicator (slip sign) indicative of a terminal stage of wear. The circumferential main grooves 20 thus formed each have a groove width within a range of 10.0 mm or more and 20.0 mm or less, and a groove depth within a range of 10.0 mm or more and 25.0 mm or less.

Dimensions of the tread pattern are each measured in an unloaded state in which the tire is mounted on a specified rim and inflated to a specified internal pressure. “Specified rim” refers to a “standard rim” defined by JATMA (The Japan Automobile Tyre Manufacturers Association, Inc.), a “Design Rim” defined by the Tire and Rim Association, Inc. (TRA), or a “Measuring Rim” defined by the European Tire and Rim Technical Organization (ETRTO). “Specified internal pressure” refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. A specified load refers to a “maximum load capacity” specified by JATMA, the maximum value in “TIRE LOAD LIMITS AT VARIOUS COLD INFLATION PRESSURES” specified by TRA, or “LOAD CAPACITY” specified by ETRTO.

The tread portion 2 includes a center land portion 31 that is a land portion 30 defined by a pair of outermost circumferential main grooves 21 that are the circumferential main grooves 20 each disposed at the outermost side in the tire width direction among the plurality of circumferential main grooves 20 and shoulder land portions 35 that are land portions 30 located on the outer sides in the tire width direction of the outermost circumferential main grooves 21 in the tire width direction. The outermost circumferential main grooves 21 in this case are the circumferential main grooves 20 located on the outermost side in the tire width direction on both sides in the tire width direction centered on the tire equatorial plane CL. In the present embodiment, the circumferential main grooves 20 are disposed one on each side of the tire equatorial plane CL in the tire width direction, and therefore the two circumferential main grooves 20 are both outermost circumferential main grooves 21.

The center land portion 31 of the tread portion 2 is the land portion 30 disposed across the tire equatorial plane CL in the tire width direction, and both sides thereof in the tire width direction are defined by the respective outermost circumferential main grooves 21. The shoulder land portions 35 are the land portions 30 located on the outer sides of the outermost circumferential main grooves 21 in the tire width direction, and the inner portions thereof in the tire width direction are defined by the outermost circumferential main grooves 21. Therefore, the outermost circumferential main grooves 21 are the circumferential main grooves 20 that separate the center land portion 31 and the shoulder land portions 35 in the tire width direction, and the center land portion 31 and the shoulder land portions 35 are disposed adjacent in the tire width direction via the outermost circumferential main grooves 21.

Among these, the center land portion 31 has a plurality of circumferential narrow grooves 40 extending in the tire circumferential direction. The circumferential narrow grooves 40 do not have wear indicators, and have a groove width of less than 5.0 mm. In the present embodiment, two circumferential narrow grooves 40 are disposed, and the two circumferential narrow grooves 40 are provided one on each side of the tire equatorial plane CL in the tire width direction. In other words, the circumferential narrow grooves 40 are disposed between the outermost circumferential main grooves 21 and the tire equatorial plane CL on both sides of the tire equatorial plane CL.

The plurality of circumferential narrow grooves 40 are disposed in the center land portion 31, and the center land portion 31 includes a plurality of land portion rows 32 defined by the circumferential narrow grooves 40. Specifically, since the two circumferential narrow grooves 40 are disposed in the center land portion 31, the center land portion 31 includes a first land portion row 32a which is a land portion row 32 having both sides in the tire width direction defined by the circumferential narrow groove 40 and the outermost circumferential main groove 21, and a second land portion row 32b which is a land portion row 32 having both sides in the tire width direction defined by the circumferential narrow grooves 40.

The first land portion row 32a is the land portion row 32 in which the inner side in the tire width direction is defined by the circumferential narrow groove 40 and the outer side in the tire width direction is defined by the outermost circumferential main groove 21, and the first land portion rows are disposed one on each side of the tire equatorial plane CL in the tire width direction. The second land portion row 32b is defined by two circumferential narrow grooves 40 on both sides in the tire width direction and is disposed across the tire equatorial plane CL in the tire width direction.

A plurality of width direction narrow grooves 50 extending in the tire width direction are disposed in the center land portion 31. The width direction narrow grooves 50 each have a groove width of less than 5.0 mm. The width direction narrow grooves 50 include first width direction narrow grooves 51 disposed in the first land portion row 32a and second width direction narrow grooves 52 disposed in the second land portion row 32b.

The first width direction narrow grooves 51 disposed in the first land portion row 32a each have one end communicating with the circumferential narrow groove 40 and the other end communicating with the outermost circumferential main groove 21. Therefore, the first land portion row 32a includes a plurality of blocks 33 defined by the first width direction narrow grooves 51 on both sides in the tire circumferential direction. In other words, the center land portion 31 includes a plurality of blocks 33 defined by the circumferential narrow grooves 40 and the width direction narrow grooves 50.

The plurality of blocks 33 included in the first land portion row 32a are arranged in the tire circumferential direction via the first width direction narrow grooves 51. In this manner, the first width direction narrow grooves 51 disposed in the first land portion row 32a and defining the blocks 33 are each formed in a crank shape extending in the tire width direction while bending at two locations.

The second width direction narrow grooves 52 disposed in the second land portion row 32b each have one end communicating with the circumferential narrow groove 40 and the other end terminating within the second land portion row 32b. The second width direction narrow grooves 52 disposed in the second land portion row 32b includes the second width direction narrow grooves 52 communicating with one circumferential narrow groove 40 of the two circumferential narrow grooves 40 defining the second land portion row 32b, and the second width direction narrow groove 52 communicating with the other circumferential narrow groove 40.

Since one end portion of each second width direction narrow groove 52 terminates within the second land portion row 32b, the second land portion row 32b in which the second width direction narrow grooves 52 are disposed is formed in a rib-like shape continuously extending in the tire circumferential direction. The second width direction narrow grooves 52 include second width direction narrow grooves 52 facing openings of the first width direction narrow grooves 51 disposed in the first land portion row 32a toward the circumferential narrow groove 40, and second width direction narrow grooves 52 not facing the openings of the first width direction narrow grooves 51 toward the circumferential narrow groove 40.

In the plurality of second width direction narrow grooves 52 communicating with one circumferential narrow groove 40, the second width direction narrow grooves 52 facing the openings of the first width direction narrow grooves 51 disposed in the first land portion row 32a toward the circumferential narrow groove 40 and the second width direction narrow grooves 52 not facing the openings are alternately disposed in the tire circumferential direction. The second width direction narrow grooves 52 facing the openings of the first width direction narrow grooves 51 toward the circumferential narrow groove 40 are longer than the second width direction narrow grooves 52 not facing the openings of the first width direction narrow grooves 51 toward the circumferential narrow groove 40.

A plurality of narrow grooves 60 within a land portion are disposed in the second land portion row 32 b, and the plurality of narrow grooves 60 has a groove width of less than 5.0 mm. The narrow grooves 60 within a land portion each extend in the tire circumferential direction over a relatively short length, and both ends thereof in the length direction are terminated within the second land portion row 32b. The plurality of narrow grooves 60 within a land portion are disposed in the tire circumferential direction in a manner separated from each other. The plurality of narrow grooves 60 within a land portion are inclined in the tire width direction with respect to the tire circumferential direction while extending in the tire circumferential direction and have opposite inclination directions in the tire width direction with respect to the tire circumferential direction between the narrow grooves 60 adjacent in the tire circumferential direction.

The narrow grooves 60 within a land portion are disposed in the central region of the second land portion row 32b in the tire width direction on the tire equatorial plane CL. The narrow grooves 60 within a land portion are formed such that the length in the tire circumferential direction is shorter than the pitch between the plurality of second width direction narrow grooves 52 in the tire circumferential direction disposed in the second land portion row 32b and located in the tire circumferential direction between the second width direction narrow grooves 52 adjacent in the tire circumferential direction.

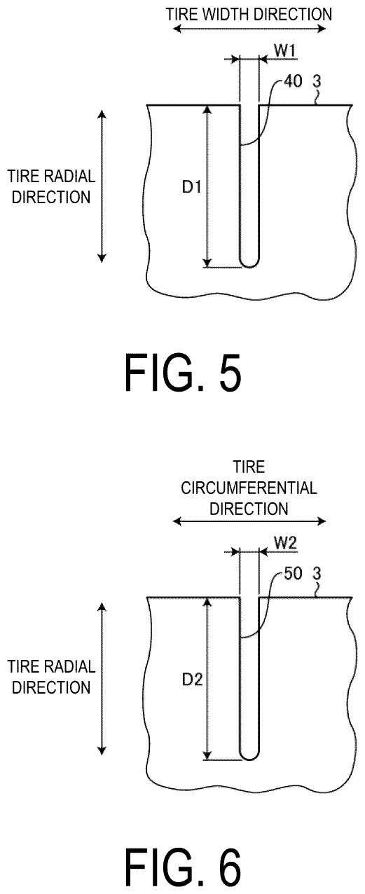

FIG. 5 is a cross-sectional view taken along line A-A of FIG. 4. The circumferential narrow grooves 40 each have a groove width W1 within a range of 0.5 mm or more and 2.0 mm or less. The circumferential narrow grooves 40 each have a groove depth D1 of 10 mm or more, the groove depth D1 being equal to or less than the groove depth of the circumferential main grooves 20. The groove width W1 of the circumferential narrow grooves 40 is preferably within a range of 0.5 mm or more and 1.8 mm or less.

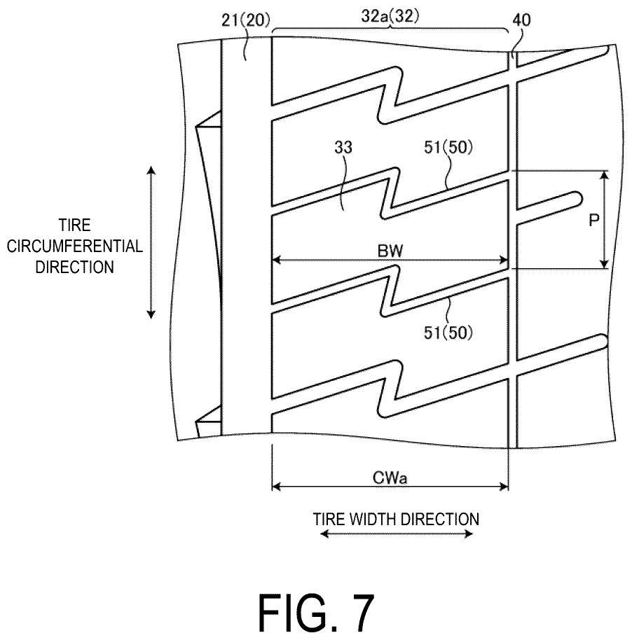

FIG. 6 is a cross-sectional view taken along line B-B of FIG. 4. The width direction narrow grooves 50 each have a groove width W2 within a range of 0.5 mm or more and 4.0 mm or less. The width direction narrow grooves 50 each have a groove depth D2 of 1 mm or more, the groove depth D2 being equal to or less than the groove depth D1 of the circumferential narrow grooves 40. The width direction narrow grooves 50 each have a groove width W2 within a range of 1.0 mm or more and 4.0 mm or less.

As illustrated in FIG. 4, a plurality of decorative grooves 65 are disposed in the shoulder land portion 35. The decorative grooves 65 are each formed in a triangular shape in a plan view. The plurality of decorative grooves 65 are disposed in the tire circumferential direction. The plurality of decorative grooves 65 disposed in the shoulder land portion 35 include those partly communicate with the outermost circumferential main groove 21 and those independently disposed in the shoulder land portion 35. The decorative grooves 65 each have a groove depth within a range of 0.5 mm or more and 5.0 mm or less.

In the center land portion 31 having both sides thereof in the tire width direction defined by the outermost circumferential main grooves 21, a ratio of a width CW of the center land portion 31 in the tire width direction to a tread development width TW is within a range of 0.40 or more and 0.65 or less. The width CW of the center land portion 31 in the tire width direction to the tread development width TW is preferably within a range of 0.45 or more and 0.60 or less. In the center land portion 31, the center of the center land portion 31 in the tire width direction is located at a position substantially on the tire equatorial plane CL.

Here, the tread development width TW is a developed dimension between ground contact edges T on both sides of the tread contact surface 3 in the tire width direction. The ground contact edge T is defined as a maximum width position in the tire width direction of the contact surface between the pneumatic tire 1 and a flat plate when the pneumatic tire 1 is mounted on a specified rim, inflated to a specified internal pressure, placed perpendicular to the flat plate, and applied with a load corresponding to a specified load. In the present embodiment, the ground contact edge T is substantially at the same position as the shoulder portion 5. The width CW of the center land portion 31 in the tire width direction is a developed dimension between the inner ends of the opening portions of the outermost circumferential main grooves 21 defining both ends of the center land portion 31 in the tire width direction.

The shoulder land portions 35 each have a ratio of the width SW of the shoulder land portion 35 in the tire width direction to the value obtained by subtracting the width CW of the center land portion 31 in the tire width direction from the tread development width TW and dividing a subtracted value by two within a range of 0.50 or more and 0.90 or less. In other words, in the shoulder land portions 35, the width SW of the shoulder land portion 35 satisfies the following formula (1):

$$\begin{matrix}0.5 \leq width SW of shoulder land portion 35 / \{ ( trend development width TW - width CW \\ of center land portion 31 ) / 2 \} \leq 0.9 \}\end{matrix} \qquad ( 1 )$$

In this case, the value obtained by subtracting the width CW of the center land portion 31 in the tire width direction from the tread development width TW and dividing a subtracted value by two is, in other words, a width DW in the tire width direction between the end portion of the center land portion 31 in the tire width direction and the ground contact edge T (See FIG. 4). Therefore, the ratio of the width SW of the shoulder land portion 35 to the width DW of the shoulder land portion 35 is within a range of 0.50 or more and 0.90 or less. The ratio of the width SW of the shoulder land portion 35 to the width DW is preferably within a range of 0.55 or more and 0.85 or less.

The plurality of land portion rows 32 included in the center land portion 31 each have a ratio of a width CWa of each land portion row 32 in the tire width direction to the width CW of the center land portion 31 in the tire width direction within a range of 0.1 or more and 0.49 or less. The land portion rows 32 of the center land portion 31 may have mutually different widths CWa among the land portion rows 32 in the tire width direction. The ratio of the width CWa of the land portion row 32 in the tire width direction to the width CW of the center land portion 31 in the tire width direction is preferably within a range of 0.25 or more and 0.45 or less.

In the circumferential belt layer 145 (see FIG. 3) included in the belt layer 14 disposed on the tread portion 2, an end portion 145a of the circumferential belt layer 145 in the tire width direction is located on the outer side of the outermost circumferential main groove 21 in the tire width direction. Furthermore, the end portion 145a of the circumferential belt layer 145 in the tire width direction is located within a range of 0.90 or less of the tread development width TW. The end portion 145a of the circumferential belt layer 145 in the tire width direction is preferably located within a range of 0.80 or less of the tread development width TW.

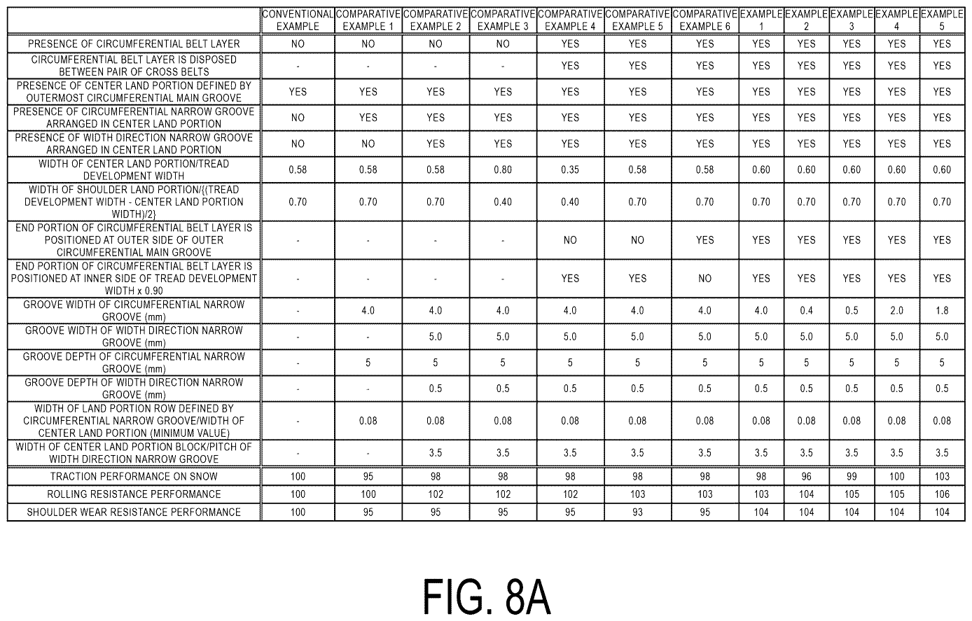

FIG. 7 is a detailed view of the blocks 33 included in the center land portion 31 illustrated in FIG. 4. The plurality of blocks 33 included in the center land portion 31 each have a ratio of a width BW of each block 33 in the tire width direction to a pitch P in the tire circumferential direction between the width direction narrow grooves 50 adjacent in the tire circumferential direction within a range of 0.3 or more and 3.0 or less. In the present embodiment, since the blocks 33 are disposed in the first land portion row 32a, the plurality of blocks 33 disposed in the first land portion row 32a each have a ratio of the width BW of the blocks 33 in the tire width direction to the pitch P in the tire circumferential direction between the first width direction narrow grooves 51 adjacent in the tire circumferential direction within a range of 0.3 or more and 3.0 or less.

The width BW in the tire width direction of the blocks 33 in this case is substantially the same size as the width CWa of the land portion row 32 in the tire width direction in which the blocks 33 are disposed. The ratio of the width BW of the blocks 33 to the pitch P between the width direction narrow grooves 50 is preferably within a range of 0.7 or more and 2.0 or less.

In the event of mounting a vehicle with the pneumatic tire 1 according to the present embodiment, the pneumatic tire 1 is mounted on a rim wheel and inflated with air inside to an inflated state and then mounted to the vehicle. When the vehicle on which the pneumatic tires are mounted travels, the pneumatic tire 1 rotates while contacting a road surface at a portion located in the lower portion of the tread ground contact surface 3 of the tread portion 2. When the vehicle on which the pneumatic tires 1 are mounted travels on a dry road surface, the vehicle travels mainly by transmitting a driving force and a braking force to the road surface and generating a turning force by friction forces between the tread ground contact surface 3 and the road surface.

When traveling on a wet road surface, water located between the tread ground contact surface 3 and the road surface and enters grooves such as the circumferential main grooves 20, the circumferential narrow grooves 40, and the width direction narrow grooves 50, and the vehicle travels while draining the water between the tread ground contact surface 3 and the road surface through these grooves. As a result, the tread ground contact surface 3 easily contacts the road surface, and the vehicle can travel by the friction force between the tread ground contact surface 3 and the road surface.

In the tread portion 2, the center land portion 31 and the shoulder land portions 35 are defined by the plurality of circumferential main grooves 20, and the circumferential grooves disposed in the center land portion 31 are the circumferential narrow grooves 40. Thus, the rigidity of the center land portion 31 can be ensured. In other words, the circumferential narrow grooves 40 close when the center land portion 31 contacts the ground and a load act on the center land portion 31, which allows the land portion rows 32 defined by the circumferential narrow grooves 40 to come into contact with each other and enables the land portion rows 32 to support each other during ground contact of the center land portion 31. Thus, the rigidity of the center land portion 31 can be increased. This ensures rigidity of a portion near the center of the tread portion 2 in the tire width direction susceptible to large loads during travel of the vehicle. Accordingly, deformation of the land portion 30 during travel of the vehicle can be suppressed, and the rolling resistance caused by the deformation of the land portion 30 can be reduced.

The plurality of width direction narrow grooves 50 extending in the tire width direction are disposed in the center land portion 31. This can ensure the rigidity of the center land portion 31 while ensuring an edge component with respect to the tire circumferential direction. This reduces the rolling resistance while ensuring the traction performance on snow which is the traction performance on snow-covered roads.

The ratio of the width CW of the center land portion 31 in the tire width direction to the tread development width TW is within the range of 0.40 or more and 0.65 or less. This can ensure the rigidity of the center land portion 31 while suppressing an excessively large difference in rigidity between the center land portion 31 and the shoulder land portions 35. In other words, when the ratio of the width CW of the center land portion 31 to the tread development width TW is less than 0.40, the width CW of the center land portion 31 is too narrow, and it may be difficult to ensure the rigidity of the center land portion 31 and reduce the rolling resistance.

When the ratio of the width CW of the center land portion 31 to the tread development width TW is greater than 0.65, the width CW of the center land portion 31 is too wide, and the width SW of the shoulder land portions 35 may be relatively too narrow. In this case, the rigidity of the shoulder land portion 35 decreases, and uneven wear known as shoulder wear tends to occur, causing the amount of wear at the shoulder land portions 35 to increase due to the difference in rigidity between the center land portion 31 and the shoulder land portions 35.

In contrast, when the ratio of the width CW of the center land portion 31 to the tread development width TW is within the range of 0.40 or more and 0.65 or less, the width SW of each of the shoulder land portions 35 is narrowed and suppress the excessive large difference in rigidity between the center land portion 31 and the shoulder land portions 35 while ensuring the rigidity of the center land portion 31. This reduces the rolling resistance while suppressing the shoulder wear.

The shoulder land portions 35 have the ratio of the width SW of the shoulder land portions 35 in the tire width direction to the value obtained by subtracting the width CW of the center land portion 31 from the tread development width TW and dividing a subtracted value by two is within the range of 0.50 or more and 0.90 or less. This can suppress the excessively large difference in rigidity between the center land portion 31 and the shoulder land portions 35 while ensuring the groove width of the outermost circumferential main grooves 21. In other words, when the value of width SW of shoulder land portion 35/{(tread development width TW−width CW of center land portion 31)/2} is less than 0.5, the width SW of the shoulder land portion 35 becomes too narrow, and the rigidity of the shoulder land portions 35 may be decreased excessively. In this case, the difference in rigidity between the center land portion 31 and the shoulder land portions 35 tends to increase, the shoulder wear may occur easily due to the difference in rigidity.

When the value of width SW of shoulder land portion 35/{(tread development width TW−width CW of center land portion 31)/2} is greater than 0.9, the width SW of the shoulder land portion 35 becomes too wide, and it may be difficult to ensure the groove width of the outermost circumferential main grooves 21 that define the shoulder land portions 35. In this case, the amount of water entering the outermost circumferential main grooves 21 when traveling on the wet road surface or the amount of snow entering the outermost circumferential main grooves 21 when traveling on the snow-covered road surface decrease. This may be difficult to ensure the wet performance which is the traveling performance on the wet road surface or the on-snow performance which is the traveling performance on the snow-covered road surface.

In contrast, when the value of width SW of shoulder land portion 35/{(tread development width TW−width CW of center land portion 31)/2} is within the range of 0.50 or more and 0.90 or less, it is possible to ensure the groove width of the outermost circumferential main grooves 21 while suppressing the groove width from becoming too narrow, thus suppressing the excessively large difference in rigidity between the center land portion 31 and the shoulder land portions 35. This suppresses the shoulder wear while ensuring the wet performance and the on-snow performance.

During travel of the vehicle on which the pneumatic tires 1 are mounted, the vehicle travels while the tread ground contact surface 3 contacts the road surface, causing the tread portion 2 to gradually wear from the tread ground contact surface 3 side of the land portion 30. At this time, the outer diameter of the portion of the tread ground contact surface 3 in the central region in the tire width direction increases easily due to centrifugal force during rotation of the pneumatic tire 1, which causes the ground contact with a large ground contact pressure.

On the other hand, the ground contact pressure of the portion of the tread ground contact surface 3 near the shoulder portions 5 tends to be small due to the difference in outer diameter from the portion in the central region in the tire width direction. This tends to cause sliding at the portion of the tread ground contact surface 3 near the shoulder portions 5 between the tread ground contact surface 3 and the road surface due to a difference in ground contact pressure caused by a difference in outer diameter from the portion in the central region in the tire width direction during rotation of the pneumatic tire 1, and wear occurs relatively easily. In other words, the shoulder wear also occurs easily due to a difference in ground contact pressure caused by a difference in outer diameter between the portion in the central region in the tire width direction and a portion near the shoulder portions 5 on the tread ground contact surface 3.

In contrast, in the pneumatic tire 1 according to the present embodiment, the belt layer 14 includes the circumferential belt layer 145 disposed between the pair of cross belts 142 and 143 and including the belt cords each having the inclination angle of 5 degrees or smaller. For this reason, the belt layer 14 can suppress the circumferential elongation in the tire circumferential direction within the range in which the circumferential belt layer 145 is disposed in the tire width direction and can suppress the increase of the outer diameter of the pneumatic tire 1 during rotation by the circumferential belt layer 145. This suppresses the occurrence of the shoulder wear due to the increase of the outer diameter in the central region of the pneumatic tire 1 in the tire width direction during rotation of the tire.

The circumferential belt layer 145 has the end portion 145a in the tire width direction located on the outer side of the outermost circumferential main grooves 21 in the tire width direction and within the range of 0.90 or less of the tread development width TW, allowing the occurrence of shoulder wear to be more reliably suppressed. In other words, when the end portion 145a of the circumferential belt layer 145 is located on the inner side of the outermost circumferential main grooves 21 in the tire width direction, the width of the circumferential belt layer 145 in the tire width direction is too narrow, and it may be difficult to suppress the increase of the outer diameter of the portion in the central region of the tread ground contact surface 3 in the tire width direction during rotation of the pneumatic tire 1. In this case, it is difficult to reduce the difference in outer diameter between the central region of the tire width direction and the portion near the shoulder portions 5 during rotation of the pneumatic tire 1, and it is difficult to reduce the difference in ground contact pressure between both portions. This may be difficult to easily obtain the effect of suppressing the shoulder wear caused by disposing the circumferential belt layer 145.

When the end portion 145a of the circumferential belt layer 145 is located outside the range of 0.90 of the tread development width TW, the width of the circumferential belt layer 145 in the tire width direction becomes wide. This causes the range for increasing the rigidity of the tread portion 2 by the circumferential belt layer 145 to tend to extend to the vicinity of the shoulder portion 5. In this case, the shoulder land portion 35 can also receive a large load, but in the portion of the shoulder land portions 35 at or near the shoulder portions 5 where the circumferential belt layer 145 is not disposed, the load against rigidity may be too large and the wear occurs easily. This may be difficult to suppress the occurrence of the shoulder wear.

In contrast, when the end portion 145a of the circumferential belt layer 145 is located on the outer side of the outermost circumferential main grooves 21 in the tire width direction and within the range of 0.90 or less of the tread development width TW, the circumferential belt layer 145 can improve the rigidity of the central region in the tire width direction while suppressing the excessive increase of the load against rigidity at or near the shoulder portions 5 of the shoulder land portions 35 where the circumferential belt layer 145 is not disposed. This suppresses the shoulder wear caused by the difference in outer diameter of the tread ground contact surface 3 during rotation of the pneumatic tire 1 and suppresses the shoulder wear caused by the excessive increase of the load against rigidity at or near the shoulder portions 5. From these results, the shoulder wear can be suppressed while reducing the rolling resistance, and the traction performance on snow can be ensured.

The circumferential narrow grooves 40 each have the groove width W1 within the range of 0.5 mm or more and 2.0 mm or less. This can reduce the rolling resistance while ensuring the wet performance and the on-snow performance. In other words, when the groove width W1 of the circumferential narrow grooves 40 is less than 0.5 mm, the groove width W1 of the circumferential narrow grooves 40 is too narrow, the amount of water entering the circumferential narrow grooves 40 when traveling on the wet road surface or the amount of snow entering the circumferential narrow grooves 40 when traveling on the snow-covered road surface decreases, and it may be difficult to ensure the wet performance or the on-snow performance. When the groove width W1 of the circumferential narrow grooves 40 is greater than 2.0 mm, the groove width W1 of the circumferential narrow grooves 40 is too wide. This may cause the circumferential narrow grooves 40 not to close easily during ground contact of the center land portion 31. In this case, when the center land portion 31 contacts the ground, the land portion rows 32 do not contact each other easily. This may be difficult to increase the rigidity of the center land portion 31.

In contrast, when the groove width W1 of the circumferential narrow grooves 40 is in the range of 0.5 mm or more and 2.0 mm or less, the rigidity of the center land portion 31 can be increased while ensuring the groove width W1 of the circumferential narrow grooves 40 by closing the circumferential narrow grooves 40 during ground contact of the center land portion 31.

As a result, the rolling resistance can be reduced while ensuring the wet performance and the on-snow performance.

The width direction narrow grooves 50 each have the groove width W2 within the range of 0.5 mm or more and 4.0 mm or less. This can more reliably reduce the rolling resistance while ensuring the traction performances on snow. In other words, when the groove width W2 of the width direction narrow grooves 50 is less than 0.5 mm, the groove width W2 of the width direction narrow grooves 50 is too narrow. This may be difficult to cause snow to enter the width direction narrow grooves 50 when traveling on the snow-covered road surface and may be difficult to ensure the traction performance on snow. When the groove width W2 of the width direction narrow grooves 50 is greater than 4.0 mm, the groove width W2 of the width direction narrow grooves 50 is too wide. This may cause the rigidity of the center land portion 31 where the width direction narrow grooves 50 are disposed to be easily decreased. In this case, the center land portion 31 deforms easily when contacting the ground, and this may cause deterioration of the rolling resistance.

In contrast, when the groove width W2 of the width direction narrow grooves 50 is within the range of 0.5 mm or more and 4.0 mm or less, the decrease in rigidity of the center land portion 31 where the width direction narrow grooves 50 are disposed can be suppressed while ensuring the groove width W2 of the width direction narrow grooves 50. This suppresses deformation of the center land portion 31 during ground contact of the center land portion 31 while allowing snow to easily enter the width direction narrow grooves 50 during travel on the snow-covered road surface. As a result, the rolling resistance can be reduced more reliably while ensuring the traction performance on snow.

The groove depth D1 of the circumferential narrow grooves 40 is 10 mm or more. This can more reliably reduce the rolling resistances. In other words, when the groove depth D1 of the circumferential narrow grooves 40 is less than 10 mm, the depth D1 of the circumferential narrow grooves 40 is too shallow. This may cause the circumferential narrow grooves 40 not to close easily during ground contact of the center land portion 31 where the circumferential narrow grooves 40 are disposed. In this case, the land portion rows 32 do not contact each other easily during ground contact of the center land portion 31. This may be difficult to increase the rigidity of the center land portion 31.

In contrast, when the groove depth D1 of the circumferential narrow groove 40 is 1 mm or more, the circumferential narrow groove 40 can close easily during ground contact of the center land portion 31 where the circumferential narrow grooves 40 are disposed, and the rigidity of the center land portion 31 can be increased. As a result, the rolling resistance can be reduced more reliably.

The groove depth D2 of the width direction narrow grooves 50 is 1 mm or more. This can more reliably reduce the rolling resistances while ensuring the traction performance on snow. In other words, when the groove depth D2 of the width direction narrow grooves 50 is less than 1 mm, the groove depth D2 of the width direction narrow grooves 50 is too shallow. This may be difficult to ensure the amount of snow that enters the width direction narrow grooves 50 when traveling on the snow-covered road surface and ensure the traction performance on snow. When the groove depth D2 of the width direction narrow grooves 50 is less than 1 mm, the groove depth D2 of the width direction narrow grooves 50 is too shallow. This may cause the width direction narrow grooves 50 not to close easily during ground contact of the center land portion 31 where the width direction narrow grooves 50 are disposed.

In contrast, when the groove depth D2 of the width direction narrow grooves 50 is 1 mm or more, the amount of snow that enters the width direction narrow grooves 50 during travel on the snow-covered road surface can be ensured. When the groove depth D2 of the width direction narrow groove 50 is 1 mm or more, the portion of the width direction narrow grooves 50 near the groove bottom can close easily during ground contact of the center land portion 31 where the width direction narrow grooves 50 are disposed, and the rigidity of the center land portion 31 can be increased. As a result, the rolling resistance can be reduced more reliably while ensuring the traction performance on snow.

The plurality of land portion rows 32 defined by the circumferential narrow grooves 40 in the center land portion 31 each have the ratio of the width CWa of the land portion row 32 to the width CW of the center land portion 31 within the range of 0.1 or more and 0.49 or less. This can reduce the rolling resistance while ensuring the wet performance and the on-snow performance. In other words, when the ratio of the width CWa of the land portion row 32 to the width CW of the center land portion 31 is less than 0.1, the width CWa of the land portion row 32 is too narrow. This may be difficult to ensure the rigidity of the land portion row 32. In this case, the amount of deformation of the land portion row 32 during ground contact of the center land portion 31 increases. This may be difficult to reduce the rolling resistance. When the ratio of the width CWa of the land portion row 32 to the width CW of the center land portion 31 is greater than 0.49, the width CWa of the land portion row 32 is too wide. This may cause the range where the circumferential narrow grooves 40 are not disposed in the center land portion 31 to become too wide. In this case, the drainage performance of the circumferential narrow grooves 40 in the center land portion 31 is not ensured easily or the amount of snow that enters the circumferential narrow grooves 40 during travel on the snow-covered road surface is reduced easily. This may be difficult to ensure the wet performance and the on-snow performance.

In contrast, when the ratio of the width CWa of the land portion row 32 to the width CW of the center land portion 31 is within the range of 0.1 or more and 0.49 or less, the rigidity of the land portion row 32 can be ensured while suppressing the increase of the range in which the circumferential narrow grooves 40 are not disposed in the center land portion 31. This reduces the amount of deformation of the land portion row 32 during ground contact of the center land portion 31, while ensuring drainage performance of the circumferential narrow grooves 40 in the center land portion 31 and facilitating the entry of snow into the circumferential narrow grooves 40 during travel on the snow-covered road surface. As a result, the rolling resistance can be reduced while ensuring the wet performance and the on-snow performance.

The center land portion 31 includes the plurality of blocks 33 defined by the circumferential narrow grooves 40 and the width direction narrow grooves 50, and the ratio of the width BW of the blocks 33 to the pitch P between the width direction narrow grooves 50 adjacent in the tire circumferential direction is within the range of 0.3 or more and 3.0 or less. This can more reliably reduce the rolling resistance. In other words, when the ratio of the width BW of the blocks 33 to the pitch P between the width direction narrow grooves 50 is less than 0.3, the width BW of the blocks 33 to the length of the blocks 33 in the tire circumferential direction may be too narrow. In this case, it is difficult to ensure the rigidity of the blocks 33 in the tire width direction, and the blocks 33 are deformed easily during ground contact of the center land portion 31. This may be difficult to reduce the rolling resistance. When the ratio of the width BW of the blocks 33 to the pitch P between the width direction narrow grooves 50 is greater than 3.0, the length of the blocks 33 in the tire circumferential direction with respect to the width BW of the blocks 33 may be too short. In this case, the rigidity of the blocks 33 in the tire circumferential direction cannot be ensured easily, and the blocks 33 are deformed easily during ground contact of the center land portion 31. This may be difficult to reduce the rolling resistance.

In contrast, when the ratio of the width BW of the blocks 33 to the pitch P between the width direction narrow grooves 50 is within the range of 0.3 or more and 3.0 or less, the rigidity of the blocks 33 in the tire width direction and the tire circumferential direction can be appropriately ensured, and the deformation amount of the blocks 33 during ground contact of the center land portion 31 can be reduced. As a result, the rolling resistance can be more reliably reduced.

### MODIFIED EXAMPLES

In the embodiment described above, two circumferential main grooves 20 are disposed in the tread portion 2, but the number of circumferential main grooves 20 may be other than two. For example, a circumferential main groove 20 different from the outermost circumferential main grooves 21 may be disposed between the two outermost circumferential main grooves 21.

In the embodiment described above, two circumferential narrow grooves 40 are disposed in the center land portion 31, but the number of circumferential narrow grooves 40 disposed in the center land portion 31 may be other than two. The number of circumferential narrow grooves 40 disposed in the center land portion 31 may be one, or three or more.

In the embodiment described above, the blocks 33 defined by the circumferential narrow grooves 40 and the width direction narrow grooves 50 in the center land portion 31 are included in the first land portion row 32a, but the blocks 33 may be included in all the land portion rows 32 of the center land portion 31.

In the embodiment described above, although the pneumatic tire 1 is used for description as an example of the tire according to an embodiment of the present technology, the tire according to the embodiment of the present technology may be a tire other than the pneumatic tire 1. The tire according to an embodiment of the present technology, may be, for example, a so-called airless tire that can be used without filling a gas.

### EXAMPLES

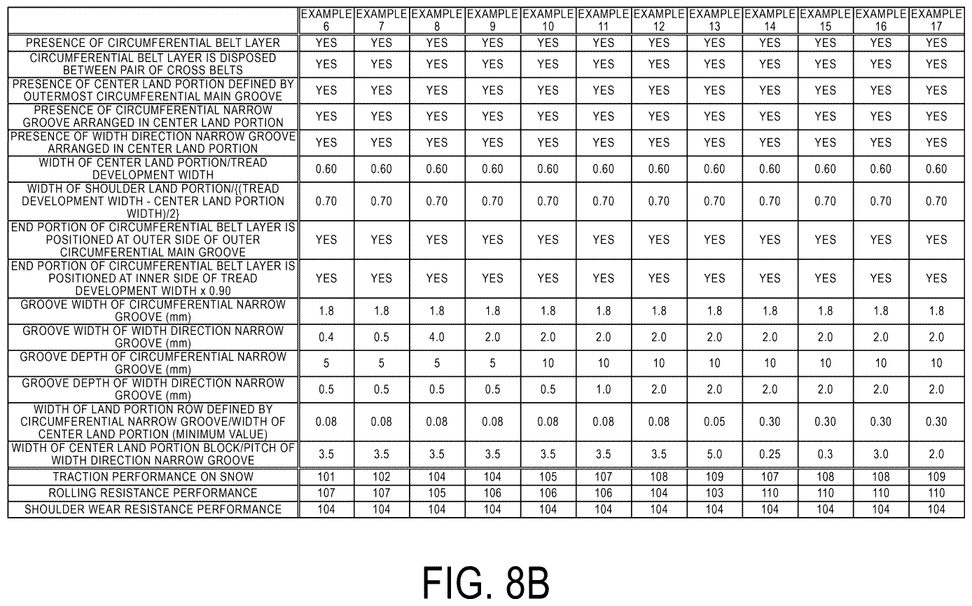

FIG. 8A and FIG. 8B are tables showing results of performance evaluation tests of pneumatic tires. In relation to the pneumatic tire 1 described above, description will be given of performance evaluation tests conducted on a pneumatic tire according to Conventional Example, the pneumatic tires 1 according to embodiments of the present technology, and pneumatic tires according to Comparative Examples to be compared with the pneumatic tires 1 according to embodiments of the present technology. Performance evaluation tests were conducted on traction performance on snow, rolling resistance performance, and shoulder wear resistance performance. The performance evaluation test was performed by mounting the pneumatic tire 1 having a tire size of 385/65R22.5 specified by ETRTO on a rim wheel having a specified rim size of 22.5″×11.75″ specified by ETRTO, adjusting the air pressure to the maximum air pressure (900 kPa) specified by ETRTO, mounting the pneumatic tire 1 on a trailer axle, and performing an actual vehicle test in a state in which the maximum load (49.03 kN) specified by ETRTO was applied.

As the evaluation method for each test item, the traction performance on snow was tested in accordance with UN Regulation No. 117 Revision 4 (UN R117-04) in which the test vehicle equipped with the test tires was driven on a snow-covered road surface, and the distance required to accelerate from the specified initial speed to the final speed was measured to calculate the acceleration. In the evaluation of the traction performance on snow, the calculated acceleration was evaluated by an index value with Conventional Example described later as 100, showing that the larger the numerical value is, the more excellent the acceleration performance on the snow-covered road surface is and the higher the traction performance on snow is. When the index value is 96 or more, the traction performance on snow is maintained at a level comparable to that of Conventional Example, thus ensuring the traction performance on snow comparable to that of Conventional Example is ensured.

The rolling resistance performance was tested in accordance with UN Regulation No. 117 Revision 4 (UN R117-04) in which the rolling resistance coefficient (ratio of rolling resistance to a load applied to the test tire) was measured at the speed of 80 km/h and the specified load of 85%. In the evaluation of the rolling resistance performance, the measured rolling resistance coefficient was evaluated by expressing it as an index with Conventional Example described below as 100, with larger numbers indicating lower rolling resistance and superior rolling resistance performance.

The evaluation test for the shoulder wear resistance performance was conducted by measuring the difference between the wear amounts of the “groove located at the position closest to the tire equatorial plane CL−the wear amount of the outermost circumferential main groove 21” after driving the test vehicle equipped with the test tires for 100,000 km and defining this difference as the shoulder wear. In the evaluation of the shoulder wear resistance performance, the measured shoulder wear resistance was evaluated by expressing it as an index with Conventional Example described below as 100, with a larger index indicating lower shoulder wear and superior shoulder wear resistance performance.

The performance evaluation tests were conducted on 24 types of pneumatic tires: the pneumatic tire of Conventional Example; pneumatic tires 1 according to Examples 1 to 17 as the pneumatic tires 1 according to embodiments of the present technology; and pneumatic tires of Comparative Examples 1 to 6 for comparison with the pneumatic tires 1 according to embodiments of the present technology. Among these, the pneumatic tires of Conventional Example and Comparative Examples 1 to 3 do not have the circumferential belt layer and differ in the presence of the circumferential narrow grooves and the width direction narrow grooves disposed in the center land portion. The pneumatic tires of Comparative Examples 4 to 6 each have the circumferential belt layer and the circumferential narrow grooves and the width direction narrow grooves are arranged in the center land portion, but do not satisfy at least one of the following conditions: the ratio of the width CW of the center land portion to the tread development width TW is within the range of 0.40 or more and 0.65 or less; the ratio of the width SW of the shoulder land portion to the value obtained by subtracting the width CW of the center land portion from the tread development width TW and dividing a subtracted value by two is within the range of 0.50 or more and 0.90 or less; the end portion of the circumferential belt layer is located on the outer side in the tire width direction than the outermost circumferential main groove; and the end portion of the circumferential belt layer is located within the range of 0.90 or less of the tread development width TW.

In contrast, in all of Examples 1 to 17 that are examples of the pneumatic tire 1 according to an embodiment of the present technology, the belt layer 14 includes the circumferential belt layer 145, in the center land portion 31, the circumferential narrow groove 40 and the width direction narrow groove 50 are disposed, and all of the following conditions are satisfied: the ratio of the width CW of the center land portion 31 to the tread development width TW is within the range of 0.40 or more and 0.65 or less; the ratio of the width SW of the shoulder land portion 35 to the value obtained by subtracting the width CW of the center land portion 31 from the tread development width TW and dividing a subtracted value by two is within the range of 0.50 or more and 0.90 or less; the end portion 145a of the circumferential belt layer 145 being located on the outer side of the outermost circumferential main groove 21 in the tire width direction; and the end portion 145a of the circumferential belt layer 145 is located within the range of 0.90 or less of the tread development width TW. Furthermore, the pneumatic tires 1 according to Examples 1 to 17 differ from each other in the groove width W1 (mm) of the circumferential narrow grooves 40, the groove width W2 (mm) of the width direction narrow grooves 50, the groove depth D1 (mm) of the circumferential narrow grooves 40, the groove depth D2 (mm) of the width direction narrow grooves 50, the minimum value of the ratio of the width CWa of the land portion rows 32 to the width CW of the center land portion 31, and the ratio of the width BW of the blocks 33 to the pitch P between the width direction narrow grooves 50.

As a result of performing the performance evaluation tests using the pneumatic tires 1, it was found as shown in FIGS. 8A and 8B that the pneumatic tires 1 according to Examples 1 to 17 can improve the rolling resistance performance and the shoulder wear resistance while suppressing the deterioration of the traction performance on snow compared to Conventional Example. In other words, the pneumatic tires 1 according to Examples 1 to 17 can reduce rolling resistance while suppressing shoulder wear, ensuring traction performance on snow.

The present disclosure includes the following technologies.

### Technology [1]

A tire, including:
a tread portion including a plurality of circumferential main grooves extending in a tire circumferential direction and a plurality of land portions defined by the circumferential main grooves; and,
a belt layer disposed in the tread portion and including a plurality of belt plies; the tread portion including
   a center land portion that is a land portion of the land portions defined by a pair of outermost circumferential main grooves each disposed at an outermost side in the tire width direction among the plurality of circumferential main grooves; and,
   shoulder land portions that are land portions of the land portions located on outer sides of the outermost circumferential main grooves in the tire width direction, in the center land portion, a plurality of circumferential narrow grooves extending in the tire circumferential direction and a plurality of width direction narrow grooves extending in the tire width direction being disposed; the belt layer including
      a pair of cross belts including belt cords having inclination directions in the tire width direction with respect to the tire circumferential direction opposite to each other;
      a circumferential belt layer disposed between the pair of cross belts and including the belt cords each having an inclination angle in the tire width direction with respect to the tire circumferential direction of 5 degrees or smaller;
      the center land portion having a ratio of a width of the center land portion in the tire width direction to a tread development width within a range of 0.40 or more and 0.65 or less;
      the shoulder land portions each having a ratio of a width of the shoulder land portions in the tire width direction to a value obtained by subtracting the width of the center land portion in the tire width direction from the tread development width and dividing a subtracted value by two within a range of 0.50 or more and 0.90 or less; and,
      the circumferential belt layer having end portions in the tire width direction located on outer sides of the outermost circumferential main grooves in the tire width direction and within a range of 0.90 or less of the tread development width.

### Technology [2]

The tire according to Technology [1], wherein the circumferential narrow grooves each have a groove width within a range of 0.5 mm or more and 2.0 mm or less.

### Technology [3]

The tire according to Technology [1] or [2], wherein the width direction narrow grooves each have a groove width within a range of 0.5 mm or more and 4.0 mm or less.

### Technology [4]

The tire according to any one of Technologies [1] to [3], wherein the circumferential narrow grooves each have a groove width within a range of 10 mm or more.

### Technology [5]

The tire according to any one of Technologies [1] to [4], wherein the width direction narrow grooves each have a groove width of 1 mm or more.

### Technology [6]

The tire according to any one of Technologies [1] to [5], wherein the center land portion includes a plurality of land portion rows defined by the circumferential narrow grooves, and the land portion rows each have a ratio of a width of the land portion rows in the tire width direction to the width of the center land portion in the tire width direction within a range of 0.1 or more and 0.49 or less.

### Technology [7]

The tire according to any one of Technologies [1] to [6], wherein the center land portion includes a plurality of blocks defined by the circumferential narrow grooves and the width direction narrow grooves, and the blocks each have a ratio of a width of the blocks in the tire width direction to a pitch in the tire circumferential direction between the width direction narrow grooves adjacent in the tire circumferential direction within a range of 0.3 or more and 3.0 or less.

What is claimed is:

1. A tire, comprising:
a tread portion comprising a plurality of circumferential main grooves extending in a tire circumferential direction and a plurality of land portions defined by the circumferential main grooves; and,
a belt layer disposed in the tread portion and comprising a plurality of belt plies; the tread portion comprising
a center land portion that is a land portion of the land portions defined by a pair of outermost circumferential main grooves each disposed at an outermost side in the tire width direction among the plurality of circumferential main grooves; and, shoulder land portions that are land portions of the land portions located on outer sides of the outermost circumferential main grooves in the tire width direction, in the center land portion, a plurality of circumferential narrow grooves extending in the tire circumferential direction and a plurality of width direction narrow grooves extending in the tire width direction being disposed, the belt layer comprising
a pair of cross belts comprising belt cords having inclination directions in the tire width direction with respect to the tire circumferential direction opposite to each other; and,
a circumferential belt layer disposed between the pair of cross belts and comprising
the belt cords each having an inclination angle in the tire width direction with respect to the tire circumferential direction of 5 degrees or smaller, the center land portion having a ratio of a width of the center land portion in the tire width direction to a tread development width within a range of 0.40 or more and 0.65 or less;
the shoulder land portions each having a ratio of a width of the shoulder land portions in the tire width direction to a value obtained by subtracting the width of the center land portion in the tire width direction from the tread development width and dividing a subtracted value by two within a range of 0.50 or more and 0.90 or less; and,
the circumferential belt layer having end portions in the tire width direction located on outer sides of the outermost circumferential main grooves in the tire width direction and within a range of 0.90 or less of the tread development width.

2. The tire according to claim 1, wherein the circumferential narrow grooves each have a groove width within a range of 0.5 mm or more and 2.0 mm or less.

3. The tire according to claim 1, wherein the width direction narrow grooves each have a groove width within a range of 0.5 mm or more and 4.0 mm or less.

4. The tire according to claim 1, wherein the circumferential narrow grooves each have a groove depth of 10 mm or more.

5. The tire according to claim 1, wherein the width direction narrow grooves each have a groove depth of 1 mm or more.

6. The tire according to claim 1, wherein the center land portion comprises a plurality of land portion rows defined by the circumferential narrow grooves, and the land portion rows each have a ratio of a width of the land portion rows in the tire width direction to the width of the center land portion in the tire width direction within a range of 0.1 or more and 0.49 or less.

7. The tire according to claim 1, wherein the center land portion comprises a plurality of blocks defined by the circumferential narrow grooves and the width direction narrow grooves, and the blocks each have a ratio of a width of the blocks in the tire width direction to a pitch in the tire circumferential direction between the width direction narrow grooves adjacent in the tire circumferential direction within a range of 0.3 or more and 3.0 or less.
